(19) United States
(12) Patent Application Publication
(10) Pub. No.: US 2019/0084463 A1
(43) Pub. Date: Mar. 21, 2019

(54) BEVERAGE CONTAINER HOLDER ASSEMBLY

(71) Applicant: GM GLOBAL TECHNOLOGY OPERATIONS LLC, Detroit, MI (US)

(72) Inventors: Timothy M. Boundy, Rochester, MI (US); Jason E. Diehl, Washington Township, MI (US); Scott J. Soderberg, Beverly Hills, MI (US)

(21) Appl. No.: 15/710,230

(22) Filed: Sep. 20, 2017

(51) Int. Cl. B60N 3/10

(52) U.S. Cl. CPC B60N 3/107; B60N 2/4686

(57) ABSTRACT

One general aspect includes a beverage container holding assembly including: a receptacle component including a first sidewall to define an open top and a closed bottom of substantially the same size and to define a shape configured to receive a sleeve component, the sleeve component including a second sidewall to define an open top and an open bottom of substantially the same size and to define a shape configured to receive a beverage container, and the first and second sidewalls including corresponding screw threads configured to cause the sleeve component to move telescopically from a first position to a second position when rotating within the receptacle component.

### INTRODUCTION

It is known to provide a beverage container holder for a vehicle. However, due to the increasing sizes of beverages, it is desirable to provide a new beverage container holding assembly for a vehicle. it is also desirable to provide a beverage container holding assembly that is telescopically adjustable to accommodate beverage containers of various heights. It is further desirable to adapt such a beverage container bolding assembly to be installed within a vehicle interior. Therefore, there is a need in the art to provide a beverage container holding assembly for a vehicle that meets these desires.

### SUMMARY

One general aspect includes a beverage container holding assembly including: a receptacle component including a first sidewall to define an open top and a closed bottom of substantially the same size and to define a shape configured to receive a sleeve component, the sleeve component including a second sidewall to define an open top and an open bottom of substantially the same size and to define a shape configured to receive a beverage container, and the first and second sidewalls including corresponding screw threads configured to cause the sleeve component to move telescopically from a first position to a second position when rotating within the receptacle component. Other embodiments of this aspect include corresponding computer systems, apparatus, and computer programs recorded on one or more computer storage devices, each configured to perform the actions of the methods.

Implementations may include one or more of the following features. The assembly where a portion of the sleeve component includes a grip configured to provide traction to facilitate the telescopic movement of the sleeve component from the first position to the second position. The assembly where: the first sidewall includes a first snap-past feature and the second sidewall includes a second snap-past feature. The assembly may also include the first and second snap-past features are configured to work in conjunction to prevent the sleeve component from being dislodged from the receptacle component after being received by the receptacle component. The assembly where: the first snap-past feature is a substantially tapered shape notch indented into the internal side of the first sidewall. The assembly may also include the second snap-past feature is a substantially tapered shape protrusion on the external side of the second sidewall. The assembly may also include where the first and second snap-past features face the opposite direction such that they correspond to create a brake to prevent the sleeve component from being dislodged from the receptacle component after being received by the receptacle component. The assembly where: the first snap-past feature is a tab internally extending from the first sidewall. The assembly may also include the second snap-past feature is an orifice through a portion of the second sidewall. The assembly may also include where the tab interlocks through the orifice so as to prevent the sleeve component from being dislodged from the receptacle component after being received by the receptacle component. The assembly where: the first sidewall includes one or more first detent features and the second sidewall includes one or more second detent features. The assembly may also include the first and second detent features are configured to work in conjunction to provide haptic feedback when the sleeve component telescopically moves from the first position to the second position while rotating in the receptacle component. The assembly where: the one or more first detent features are protrusions. The assembly may also include the one or more second detent features are indents. The assembly may also include where the one or more protrusions click into the one or more indentations to provide haptic feedback. The assembly where: the one or more first detent features are notches along portions of the first sidewall. The assembly may also include the one or more second detent features are protrusions along the sides of the second sidewall screw thread. The assembly may also include where the one or more protrusions click into the one or more notches to provide haptic feedback. The assembly where: the one or more first detent features include a cavity, spring, and ball bearing, where the spring and ball bearing are inserted into the cavity such that the spring biases the ball bearing towards the internal side of the first sidewall. The assembly may also include the one or more second detent features are indents along a portion of the external side of the second sidewall; and where the biased one or more ball bearings click into the one or more indents to provide haptic feedback. The assembly where the receptacle component and the sleeve component are manufactured from plastic, metal, rubber, fiberglass, wood, ceramic material, or some combination thereof.

One general aspect includes a beverage container holding assembly for installation in an interior of a vehicle, the assembly including: a receptacle component configured to be disposed in a vehicle interior surface, the receptacle component includes a first sidewall to define an open top and a closed bottom of substantially the same size and to define a shape configured to receive a sleeve component. The beverage container holding assembly also includes the sleeve component includes a second sidewall to define an open top and an open bottom of substantially the same size and to define a shape configured to receive a beverage container, the sleeve component further includes a lip with a grip; the first and second sidewalls include corresponding screw threads configured to cause the sleeve component to move telescopically from a first position to a second position while rotating within the receptacle component. The beverage container holding assembly also includes the first sidewall includes a first snap-past feature and the second sidewall includes a second snap-past feature, where the first and second snap-past features are configured to work in conjunction to prevent the sleeve component from being dislodged from the receptacle component after being received by the receptacle component. The beverage container holding assembly also includes the first sidewall including a first detent feature and the second sidewall including one or more second detent features, where the first and second detent features are configured to work in conjunction to provide haptic feedback when the sleeve component telescopically moves from the first position to the second position while rotating in the receptacle component; and the grip configured to facilitate the telescopic movement of the sleeve component from the first position to the second position. Other embodiments of this aspect include corresponding computer systems, apparatus, and computer programs recorded on one or more computer storage devices, each configured to perform the actions of the methods.

Implementations may include one or more of the following features. The assembly where: the first snap-past feature is a substantially tapered shape notch indented into the internal side of the first sidewall. The assembly may also include the second snap-past feature is a substantially tapered shape protrusion on the external side of the second sidewall. The assembly may also include where the first and second snap-past features face the opposite direction such that they correspond to create a brake to prevent the sleeve component from being dislodged from the receptacle component after being received by the receptacle component. The assembly where: the first snap-past feature is a tab internally extending from the first sidewall. The assembly may also include the second snap-past feature is an orifice through a portion of the second sidewall; and where the tab interlocks through the orifice so as to prevent the sleeve component from being dislodged from the receptacle component after being received by the receptacle. The assembly where: the first detent feature is a protrusion. The assembly may also include the one or more second detent features are indents. The assembly may also include where the protrusion clicks into each of the one or more indentations to provide haptic feedback. The assembly where: the first detent feature is a notch along portions of the first sidewall. The assembly may also include the one or more second detent features are protrusions along the sides of the second sidewall screw thread. The assembly may also include where each of the one or more protrusions click into the notch to provide haptic feedback. The assembly where: the first detent feature includes a cavity, spring, and ball bearing, where the spring and the ball bearing are inserted into the cavity such that the spring biases the ball bearing towards the internal side of the first sidewall. The assembly may also include the one or more second detent features are indents along a portion of the external side of the second sidewall; and where the biased ball bearing clicks into the one or more indents to provide haptic feedback. The assembly where the receptacle component and the sleeve component are manufactured from plastic, metal, rubber, fiberglass, wood, ceramic material, or some combination thereof.

One general aspect includes a method of installing a beverage container holding assembly into an interior of a vehicle, the method including: disposing a receptacle component in a vehicle interior surface, where the receptacle component includes a first sidewall to define an open top and a closed bottom of substantially the same size and to define a shape configured to receive a sleeve component. The method also includes heat staking the receptacle component to the vehicle interior surface; installing the sleeve component within the receptacle component, where the sleeve component includes a second sidewall to define an open top and an open bottom of substantially the same size and to define a shape configured to receive a beverage container, and where the first and second sidewalls includes corresponding screw threads configured to cause the sleeve component to move telescopically from a first position to a second position when rotating within the receptacle component; and allowing the sleeve component to move telescopically from a first position to a second position upon being rotated within the receptacle component. Other embodiments of this aspect include corresponding computer systems, apparatus, and computer programs recorded on one or more computer storage devices, each configured to perform the actions of the methods.

Implementations may include one or more of the following features. The method further including: where the first sidewall includes a first snap-past feature and the second sidewall includes a second snap-past feature, and where the first and second snap-past features are configured to work in conjunction to prevent the sleeve component from being dislodged from the receptacle component after being received by the receptacle component. The method may also include allowing the first and second snap-past features to work in conjunction to prevent the sleeve component from being dislodged from the receptacle component after being received by the receptacle component. The method further including: where the first sidewall includes one or more first detent features and the second sidewall includes one or more second detent features, and where the first and second detent features are configured to work in conjunction to provide haptic feedback when the sleeve component telescopically moves from the first position to the second position upon being rotated within the receptacle component. The method may also include allowing the first and second detent features to provide haptic feedback when the sleeve component telescopically moves from the first position to the second position.

The above features and advantages and other features and advantages of the present teachings are readily apparent from the following detailed description for carrying out the teachings when taken in connection with the accompanying drawings.

### BRIEF DESCRIPTION OF THE DRAWINGS

FIG. 1 shows an environment in which an exemplary beverage container holding assembly may be implemented according one embodiment;

FIG. 2 shows a peripheral view of an exemplary beverage container holding assembly according to one embodiment;

FIG. 3 shows a side view of the exemplary beverage container holding assembly of FIG. 2 according to an aspect of the embodiment;

FIG. 4 shows a side view of the exemplary beverage container holding assembly of FIG. 2 according to another aspect of the embodiment;

FIG. 5 shows a representation of exemplary assembly screw threads according to one embodiment;

FIG. 6 shows a representation of exemplary assembly screw threads according to another embodiment;

FIG. 7 shows a vertical side view of exemplary assembly screw threads according to another embodiment;

FIG. 8 shows a side view of an exemplary holding assembly according to another embodiment;

FIG. 9 shows a forward facing view of an exemplary receptacle screw thread and sleeve screw thread according to an embodiment; and

FIG. 10 shows a flow chart of the steps to install an exemplary beverage container holding assembly.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

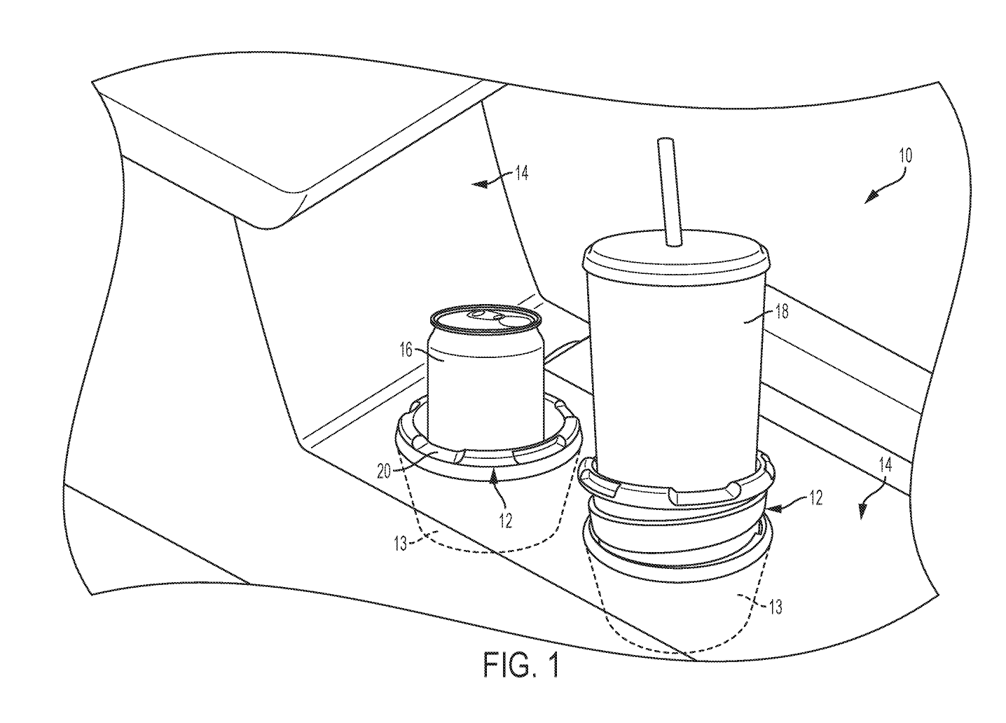

Referring to FIG. 1, the interior of a vehicle is generally indicated at 10 and includes two similar beverage container holding assemblies 12 installed onto a center console 14, which is generally positioned between the vehicle operator seat and the vehicle passenger seat (not shown). Each holding assembly 12 is telescopically adjustable to accommodate beverage containers of various heights. For example, a vehicle passenger/operator may have their assembly 12 hold both short beverage containers 16 such as, but not limited to, cans and juice boxes as well as tall beverage containers 18 such as, fountain soda cups and insulated coffee containers. For instance, the assembly 12 may be in a low orientation (shown towards the left) which is proper for holding short containers 16 and then may be adjusted to extend vertically to a high orientation (shown towards the right) for holding tall containers 18. In order to change the assembly 12 from this low orientation to the high orientation, a vehicle passenger simply needs to rotate the installed assembly 12 via, for example, a grip 20 that rises above the rest of console 14. It should be understood that holding assembly 12 may also be installed at other locations within the interior 10 such as, but not limited to, the vehicle's dash board (not shown), a vehicle seat (not shown), a vehicle seat armrest (not shown), or on the side of a vehicle door not shown).

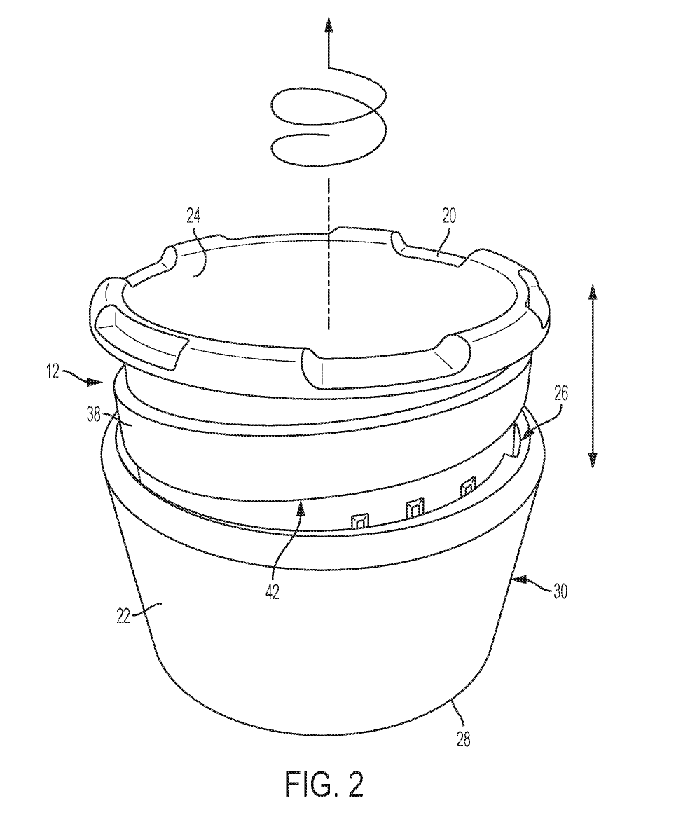

As shown in FIGS. 2 through 4, an embodiment of the holding assembly 12 includes two distinctive components, a receptacle 22 and a sleeve 24. The receptacle 22 is generally molded into a cylindrically shaped cup. As such, receptacle 22 has an open top 26 and closed bottom 28 and a sidewall 30 having a uniform and circular cross section (i.e., the circular cross section of top 26 is equivalent to that of bottom 28). The receptacle 22 is moreover the aspect of holding assembly 12 which can be installed onto the interior surface 14 (e.g., the center console or seat armrest). As such, receptacle 22 may be inserted into an orifice or cavity 13 (FIG. 1) located somewhere within interior 10 and subsequently heat staked for permanent installation. As a result, the closed bottom 28 may keep beverage containers from falling through the orifice/cavity 13 as well as provide a collection place for liquids accidentally spilled out of the container or perspiration dripping off the container 16, 18. Furthermore, a flange 32, extending laterally from the open top 26, may keep receptacle 22 adequately situated after being inserted the orifice/cavity 13 as well as help keep receptacle 22 level with the surrounding surface 14. In addition, receptacle 22 may be manufactured by an injection molding process and may be made of plastic. However, it should be understood that receptacle 22 may be made of metal, rubber, fiberglass, wood, ceramic material and manufactured through known processes.

The sleeve 24 is generally molded into a cylindrical shape having an open top 34 and open bottom 36 and a sidewall 38 with a uniform circular cross section. Sleeve 24 can also be inserted into receptacle 22. As a result, when a beverage container 16, 18 is placed into the holding assembly 12, a portion of the container 16, 18 will rest below the sleeve's open bottom 36 and within the confines of receptacle 22. Similar to receptacle 22, sleeve 24 may be manufactured by an injection molding process and may be made of plastic. However, it should be understood that receptacle 22 may be made of metal, rubber, fiberglass, wood, ceramic material and manufactured through known processes.

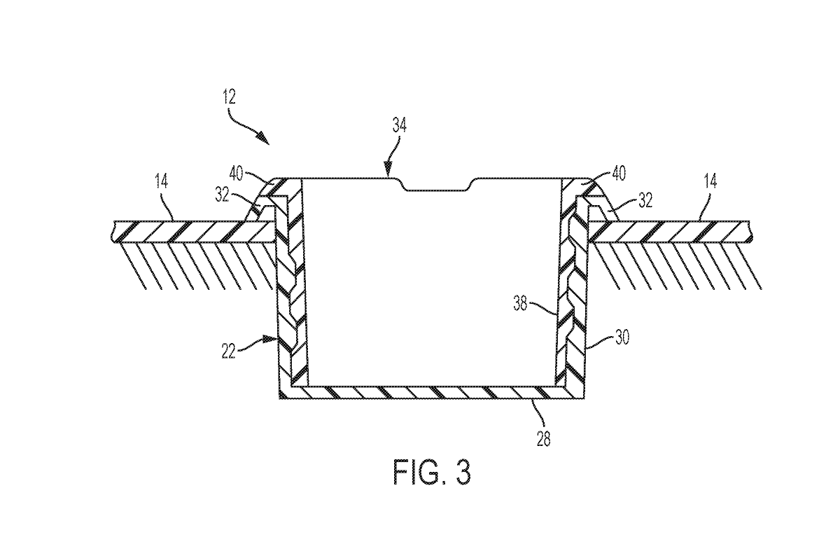

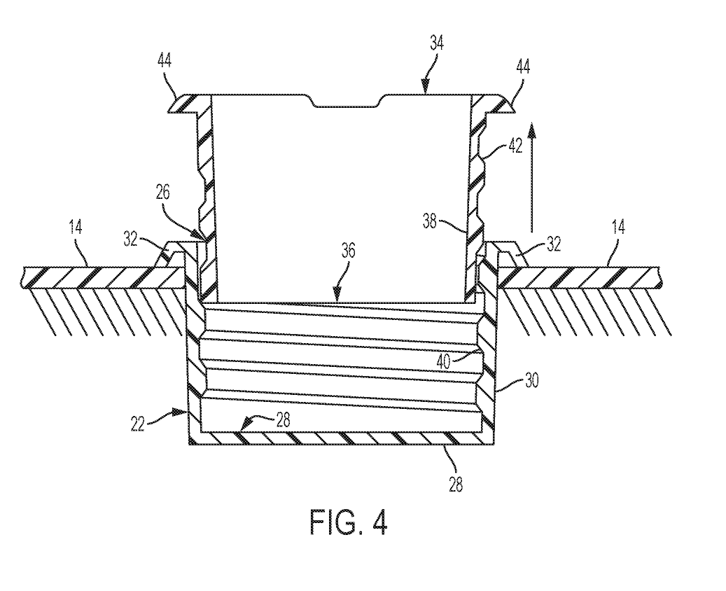

Screw threads 40, 42 on the internal facing side of the receptacle sidewall (40) as well as external side of the sleeve sidewall (42) correspond to allow the sleeve 24 to be rotated in one direction so as to screw down into receptacle 22 to a retracted first position (FIG. 3) and rotated in opposite direction so as to be unscrewed to an extended second position (FIG. 4). A lip 44, extending laterally from the open top 34, restricts sleeve 24 from being screwed down past the first position, and thus difficult to unscrew the sleeve 24 back to the second position. Grip 20, which may be molded to sleeve 24, is located on lip 40 to help a user (not shown) rotate sleeve 24 within receptacle 22. It should be understood the first position is one in which sleeve 24 has been screwed down in receptacle 22 until its lip 44 has met flange 32. Moreover, the second position is one in which sleeve 24 has been substantially unscrewed to a point that allows tall beverage containers 18 to properly sit in holding assembly 12 (i.e., exposing approximately ¾-⅞ the length of sleeve 24 from beyond the top of receptacle 22).

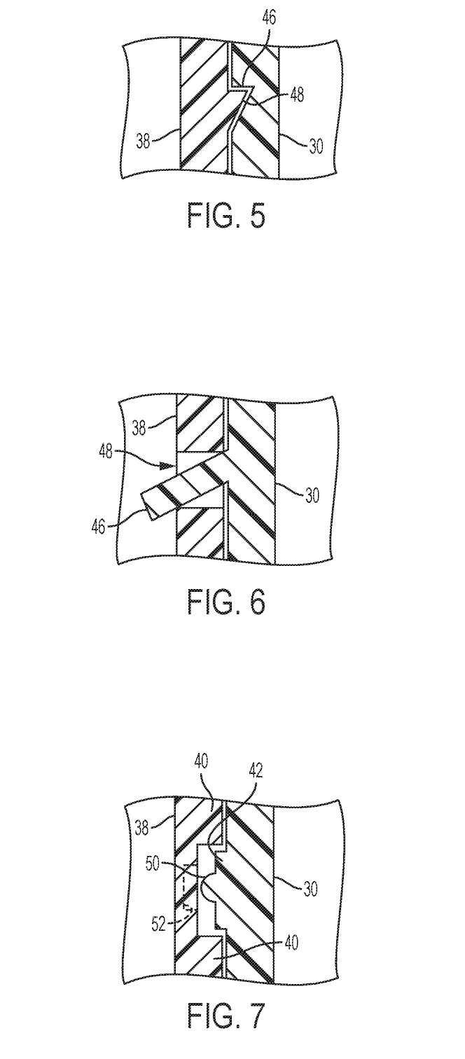

As shown in FIG. 5, in order to keep the installed sleeve 22 from being unintentionally removed from receptacle 22, holding assembly 12 may include some form of a snap-past lock system. In this embodiment, the receptacle sidewall 30 includes a tapered shaped (ramp shaped) notch 46 that is indented into the center facing side of this wall 30. Correspondingly, the sleeve sidewall 38 includes a tapered shape protrusion 48 on the external side of the wall 38 which is facing the opposite direction as notch 46. Accordingly, when attempting to rotate sleeve 24 past the second position, tapered protrusion 48 will slide into and interlock with tapered notch 46 to prevent sleeve 24 from being dislodged out of receptacle 22. The non-tapered side of notch 46 therefore creates a break by preventing the portion of thread 42 with the non-tapered side of protrusion 48 from sliding any further along screw thread 40. As shown in FIG. 6, another embodiment of this snap-past lock system includes the receptacle sidewall 30 having a tab 46 which extends internally (i.e., towards the center of receptacle 22). Correspondingly, the sleeve sidewall 38 includes an orifice 48. Accordingly, tab 46 slides through orifice 48 and interlocks with the orifice 48 so as to prevent the sleeve 24 from being dislodged out of receptacle 22. Skilled artisans will see that other exemplary snap-past lock systems, generally known in this field, may be incorporated into the holding assembly to ensure the installed sleeve 22 cannot unintentionally be removed from receptacle 22.

As shown in FIG. 7, both receptacle 22 and sleeve 24 may also include detent features 50, 52 to provide haptic feedback when sleeve 24 moves telescopically from the first position to the second position. In this embodiment, the detent features located internally on the receptacle sidewall 30 are protrusions 50 such as, but not limited to, slightly raised bumps (as shown). Whereas, the detent features located externally on the sleeve sidewall 38 are indents 52 (i.e., notches). As a result, when sleeve 24 rotates within receptacle 22, and the corresponding screw threads 40, 42 slide past each other, protrusions 50 click into indents 52 to provide haptic feedback and let user know sleeve 24 is rotatably moving from one position to another (i.e., from first position to second position).

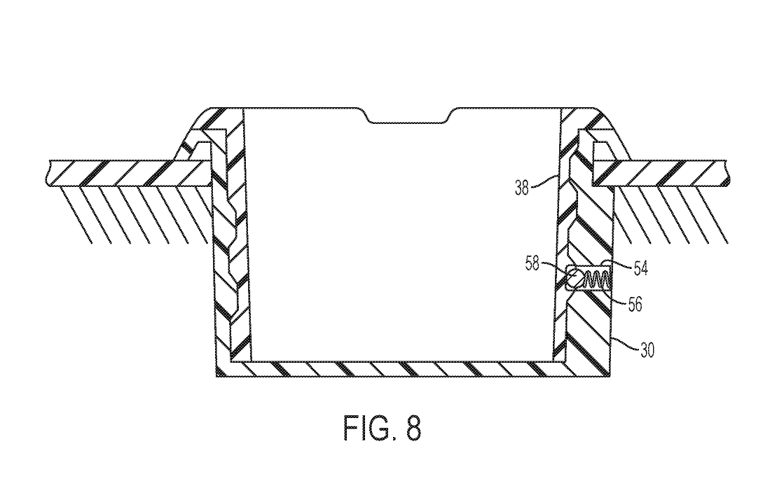

As shown in FIG. 8, in another embodiment, the detent feature located internally on the receptacle sidewall 30 may include a cavity 54, spring 56, and ball bearing 58. As follows, spring 56 and ball bearing 58 are positioned within cavity 54 and biased towards the internal side of sleeve sidewall 38 via spring 56. Whereas, the detent features located externally on the sleeve sidewall 38 are external indents 52 that at least a portion of the ball bearing 58 can fit into. As a result, when sleeve 24 rotates within receptacle 22, and the corresponding screw threads 40, 42 slide past each other, ball bearing 58 temporarily clicks into indents 52 to provide haptic feedback and let user know sleeve 24 is rotatably moving within receptacle 22.

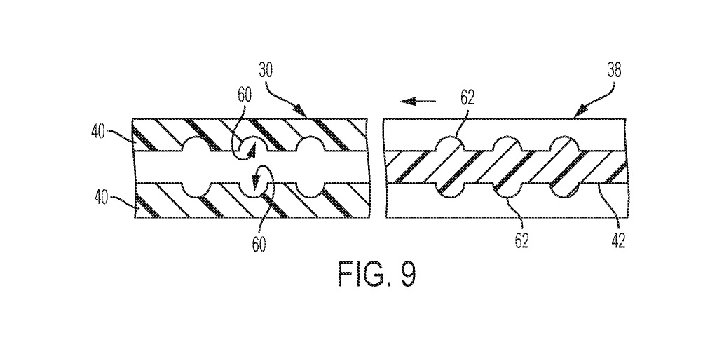

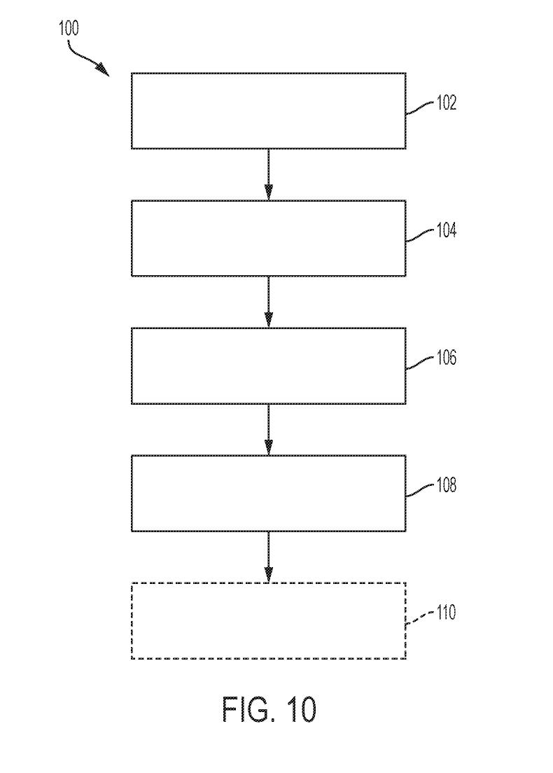

As shown in FIG. 9, in another embodiment, detent features may be a series of indents 60 located along a portion of the sides of opposite screw threads 40, along a portion of receptacle sidewall 30. Whereas, the detent features located externally on the sleeve sidewall 38 are a series of protrusions 62 (e.g., bumps) positioned along a portion of both sides of screw thread 42. As a result, when sleeve 24 rotates within receptacle 22, and the corresponding screw threads 40, 42 slide past each other, protrusions 62 click into indents 60, to provide haptic feedback and let user know sleeve 24 is rotatably moving from one position to another. Skilled artisans will see that other exemplary detent embodiments, generally known in this field, may be incorporated into the holding assembly to provide haptic feedback.

A method for installing holding assembly 12 is represented by the flow chart of FIG. 10. The method of installation 100, begins with step 102 in which the installer disposes receptacle 22 into orifice 13 of interior surface 10. In step 104, receptacle 22 is permanently installed in the orifice through the implementation of a generally known heat staking process. In step 106, the installer will screw sleeve 24 into receptacle 30. This may include screwing sleeve 24 down so the snap-lock system is set to prevent sleeve 24 from being dislodged out of receptacle 22 (as discussed above). In step 108, the installer should ensure sleeve 24 is free to move telescopically up and down upon being installed in receptacle. This may include removing any items within the vehicle interior 10 that may restrict vertical movement of sleeve 24. In optional step 110, when assembly 12 includes detents, the installer should ensure the detent features 50, 52 are able to provide haptic feedback while sleeve 24 rotates and moves vertically within receptacle 22.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,”

1. A beverage container holding assembly comprising:
a receptacle component molded into a cylindrically shaped cup, the receptacle component comprising a first sidewall, open top, a closed bottom, and having a uniform and circular cross section;
a sleeve component molded into a cylindrical shape with a uniform cross section, the sleeve component comprising a second sidewall, open top, and an open bottom, wherein the sleeve component can be inserted into the receptacle component and can also receive a beverage container;
the first and second sidewalls comprising corresponding screw threads configured to cause the sleeve component to move telescopically from a first position to a second position when rotating within the receptacle component;
wherein the internal side of the first sidewall comprising one or more first detent features and the external side of the second sidewall comprising a plurality of second detent features; and
wherein the first and second detent features are configured to work in conjunction to provide repeated haptic feedback adapted to let a user know when the sleeve component telescopically moves from the first position to the second position while the sleeve component is rotating in the receptacle component.

2. The assembly of claim 1, wherein a portion of the sleeve component comprising a grip configured to provide traction to facilitate the telescopic movement of the sleeve component from the first position to the second position.

3. The assembly of claim 1, wherein:
the first sidewall comprising a first snap-past feature and the second sidewall comprising a second snap-past feature; and
the first and second snap-past features are configured to work in conjunction to prevent the sleeve component from being dislodged from the receptacle component after being received by the receptacle component.

4. The assembly of claim 3, wherein:
the first snap-past feature is a tapered shape notch indented into the internal side of the first sidewall;
the second snap-past feature is a tapered shape protrusion on the external side of the second sidewall; and
wherein the first and second snap-past features face the opposite direction such that they correspond to create a brake to prevent the sleeve component from being dislodged from the receptacle component after being received by the receptacle component.

5. The assembly of claim 3, wherein:
the first snap-past feature is a tab internally extending from the first sidewall;
the second snap-past feature is an orifice through a portion of the second sidewall; and
wherein the tab interlocks through the orifice so as to prevent the sleeve component from being dislodged from the receptacle component after being received by the receptacle component.

6. (canceled)

7. The assembly of claim 1, wherein:
the one or more first detent features are protrusions;
the second detent features are indents; and
wherein the one or more protrusions click into the indentations to provide haptic feedback.

8. The assembly of claim 1, wherein:
the one or more first detent features are notches along portions of the first sidewall;
the second detent features are protrusions along the sides of the second sidewall screw thread; and
wherein the one or more protrusions click into the notches to provide haptic feedback.

9. The assembly of claim 1, wherein:
the one or more first detent features comprising a cavity, spring, and ball bearing, wherein the spring and ball bearing are inserted into the cavity such that the spring biases the ball bearing towards the internal side of the first sidewall;
the second detent features are indents along a portion of the external side of the second sidewall; and
wherein the biased one or more ball bearings click into corresponding indents of the plurality of indents to provide haptic feedback.

10. The assembly of claim 1, wherein the receptacle component and the sleeve component are manufactured from plastic, metal, rubber, fiberglass, wood, ceramic material, or some combination thereof.

11. A beverage container holding assembly for installation in an interior of a vehicle, the assembly comprising:
a receptacle component molded into a cylindrical shaped cup configured to be disposed in a vehicle interior surface, the receptacle component comprising a first sidewall, open top, a closed bottom, and having a uniform and circular cross section;
a sleeve component molded into a cylindrical shape with a uniform cross section, the sleeve component comprising a second sidewall, open top, an open bottom, and a lip with a grip, wherein the sleeve component can be inserted into the receptacle component and can also receive a beverage container;
the first and second sidewalls comprising corresponding screw threads configured to cause the sleeve component to move telescopically from a first position to a second position while rotating within the receptacle component;
the first sidewall comprising a first snap-past feature and the second sidewall comprising a second snap-past feature, wherein the first and second snap-past features are configured to work in conjunction to prevent the sleeve component from being dislodged from the receptacle component after being received by the receptacle component;
the first sidewall comprising a detent feature and an external side of the second sidewall comprising a plurality of indents, wherein the detent feature comprises a cavity, spring, and ball bearing, and wherein the spring and the ball bearing are inserted into the cavity such that the spring biases the ball bearing towards the internal side of the first sidewall, and wherein the biased ball bearing clicks into the indents to provide repeated haptic feedback adapted to let a user know when the sleeve component telescopically moves from the first position to the second position while the sleeve component is rotating in the receptacle component; and
the grip configured to facilitate the telescopic movement of the sleeve component from the first position to the second position.

12. The assembly of claim 11, wherein:
the first snap-past feature is a tapered shape notch indented into the internal side of the first sidewall;
the second snap-past feature is a tapered shape protrusion on the external side of the second sidewall; and
wherein the first and second snap-past features face the opposite direction such that they correspond to create a brake to prevent the sleeve component from being dislodged from the receptacle component after being received by the receptacle component.

13. The assembly of claim 11, wherein:
the first snap-past feature is a tab internally extending from the first sidewall;
the second snap-past feature is an orifice through a portion of the second sidewall; and
wherein the tab interlocks through the orifice so as to prevent the sleeve component from being dislodged from the receptacle component after being received by the receptacle.

14. (canceled)

15. (canceled)

16. (canceled)

17. The assembly of claim 11, wherein the receptacle component and the sleeve component are manufactured from plastic, metal, rubber, fiberglass, wood, ceramic material, or some combination thereof.

18. A method of installing a beverage container holding assembly into an interior of a vehicle, the method comprising:
disposing a receptacle component molded into a cylindrically shaped cup in a vehicle interior surface, wherein the receptacle component comprising a first sidewall, open top, a closed bottom, and having a uniform and circular cross section;
heat staking the receptacle component to the vehicle interior surface;
installing a sleeve component molded into a cylindrical shape with a uniform cross section, the sleeve component within the receptacle component, wherein the sleeve component comprising a second sidewall, open top, and an open bottom of the same size and to define a shape configured to receive a beverage container, and wherein the first and second sidewalls comprising corresponding screw threads configured to cause the sleeve component to move telescopically from a first position to a second position when rotating within the receptacle component;
allowing the sleeve component to move telescopically from a first position to a second position upon being rotated within the receptacle component;
wherein the first sidewall comprising a detent feature and an external side of the second sidewall comprising a plurality of indents, wherein the detent feature comprises a cavity, spring, and ball bearing, and wherein the spring and the ball bearing are inserted into the cavity such that the spring biases the ball bearing towards the internal side of the first sidewall, and wherein the biased ball bearing clicks into the indents to provide repeated haptic feedback adapted to let a user know when the sleeve component telescopically moves from the first position to the second position while the sleeve component is rotating in the receptacle component; and
allowing the first and second detent features to provide haptic feedback when the sleeve component telescopically moves from the first position to the second position.

19. The method of claim 18, further comprising:
wherein the first sidewall comprising a first snap-past feature and the second sidewall comprising a second snap-past feature, and wherein the first and second snap-past features are configured to work in conjunction to prevent the sleeve component from being dislodged from the receptacle component after being received by the receptacle component; and
allowing the first and second snap-past features to work in conjunction to prevent the sleeve component from being dislodged from the receptacle component after being received by the receptacle component.

20. (canceled)
